(19) United States
(12) Patent Application Publication
(10) Pub. No.: US 2017/0267222 A1
(43) Pub. Date: Sep. 21, 2017

(54) PARK BRAKE ELECTRICAL ACTUATION COMPLEMENTING DRIVE SHAFT RETARDERS

(71) Applicant: Soterea, Inc., Cranbury, NJ (US)

(72) Inventor: Carlos M. Antunes, Union, NJ (US)

(21) Appl. No.: 15/465,275

(22) Filed: Mar. 21, 2017

Related U.S. Application Data
(60) Provisional application No. 62/310,842, filed on Mar. 21, 2016.

(51) Int. Cl. B60T 13/58; B60T 15/54; B60T 7/12; B60T 13/36; B60T 13/68

(52) U.S. Cl. CPC B60T 13/586; B60T 13/36; B60T 13/683; B60T 7/12; B60T 15/54

(57) ABSTRACT

Park Brake Automatic Application System (PBAAS) for a vehicle includes at least one electronically controlled air valve (ECAV) and an electronic controller. The electronic controller is responsive to at least one input signal to generate a control signal which controls the ECAV when the PBAAS is activated. The ECAV is responsive to the control signal to interrupt a flow of pressurized air to the supply port of a park brake valve by closing a normally open port. Concurrent with the closing, the ECAV opens a normally closed port to provide a flow path to cause pressurized air to be exhausted from a park brake air chamber.

### CROSS-REFERENCE TO RELATED APPLICATIONS

This application claims priority to U.S. Provisional Patent Application No. 62/310,842 filed on Mar. 21, 2016. The content of the above patent application is incorporated by reference in its.

### BACKGROUND

Statement of the Technical Field

The technical field of this disclosure comprises motor vehicles, and more particularly methods and systems for implementing secondary braking systems.

Description of the Related Art

The brake-assembly components at the wheels of a vehicle are generally called the foundation components because they form the primary basis on which the rest of the braking system is designed to operate. Many heavy duty and bus vehicle fleet owners and operators around the world also use a secondary braking system to reduce vehicle speed. These can vary in application method and operation type. For example, the Electro-Magnetic Driveshaft Retarder (hereafter ‘EMDSRs’), are of growing interest and are poised for growth. Completely separate from the foundation brakes which comprise the primary means of braking, an EMDSR is triggered electronically by manual or automated means and provides the driver with an alternate method of reducing the speed of the vehicle. Generally, owners and operators alike consider EMDSRs to be advantageous to their vehicle operations.

A shortcoming of EMDSR is that EMDSR will disengage prior to the vehicle coming to a complete stop. The EMDSR disengages because electric retarders produce a torque proportional to speed, therefore as the vehicle speed decreases so does the braking torque. At a low-speed threshold, electric retarders disengage because there is not enough braking torque to effectively slow the vehicle. When this happens, the driver applies the foundation brakes in order to fully stop the vehicle.

### SUMMARY

Embodiments concern a method for automatic activation of a park brake. The method comprises providing a source of pressurized air in a vehicle. The pressurized air is provided to a park brake air chamber using a park brake valve which maintains the park brake in a park brake released condition. The method further comprises interrupting a flow of the pressurized air to a supply port of the park brake valve and concurrent with the interrupting, providing a flow path to also allow pressurized air to pass from the park brake chamber. For example, the pressurized air can be caused to be exhausted through an exhaust port of the park brake valve. Exhausting air from the park brake air chamber applies the parking brake for slowing the vehicle.

Embodiments also concern a Park Brake Automatic Application System (PBAA). The system uses a source of pressurized air and a park brake valve which is adapted to control a supply of the pressurized air to a park brake air chamber. For example, the park brake air valve can be configured so as to maintain the park brake in a park brake released condition for so long as pressurized air is provided to a supply port of the park brake valve. The system further includes an electronically controlled air valve (ECAV). The ECAV includes a first port for receiving a flow of the pressurized air, and a normally open port which is coupled to a supply port of the park brake valve to communicate the pressurized air from the first port to the supply port. The ECAV can also include a normally closed port which is configured to cause a flow of pressurized air to be exhausted from the park brake air chamber.

The system can further include an electronic controller which is responsive to at least one input signal to generate a control signal to control the ECAV when the PBAAS is activated. The ECAV is responsive to the control signal to interrupt a flow of the pressurized air to the supply port of the park brake valve by closing the normally open port and concurrently opening the normally closed port. The ECAV is configured so that by opening the normally closed port a flow path is provided to allow pressurized air to be exhausted from a park brake air chamber. For example, the pressurized air can be caused to be exhausted through an exhaust port of a park brake valve.

### BRIEF DESCRIPTION OF THE DRAWINGS

Embodiments will be described with reference to the following drawing figures, in which like numerals represent like items throughout the figures, and in which:

FIG. 1 is an illustration of an exemplary vehicle in which a parking brake automatic application system (PBAAS) disclosed herein can be used to facilitate secondary braking operations.

FIG. 2 is a block diagram of an exemplary brake system architecture which is useful for understanding a PBAAS disclosed herein.

FIG. 3 is an illustration of an exemplary architecture for a controller which can be used for implementing a PBAAS disclosed herein.

FIG. 4 is an illustrative view of a brake system, which is useful for understanding certain aspects of the PBAAS in FIG. 1

FIG. 5 is an illustrative view of an electronic solenoid air valve that is useful for understanding the PBAAS in FIG. 1.

FIG. 6 is a flow diagram which is useful for understanding an exemplary method for implementing a PBAAS disclosed herein.

FIG. 7 is a flow diagram which is useful for understanding an exemplary method for implementing a PBAAS disclosed herein.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Air brake systems are used on certain vehicles such as busses and trucks. These air brake systems generally includes several brake system components. The brake-assembly components at the wheels of a vehicle are commonly referred to as the foundation components. The foundation components are the brake components (usually comprising mechanical parts) which are located in or around the wheels of the vehicle, and can be selectively controlled by the air brake system. The air brake system can include various components such as service brakes, parking brakes, a control pedal, and an air storage tank for pressurized air. The service brakes are used under normal driving conditions for slowing or stopping. To apply the service brakes the driver exerts force on the brake pedal which causes a flow of pressurized air to a brake chamber. The pressurized air causes the brake force to be applied at a conventional brake disc or a brake drum.

In the case of the parking brake, the system is usually designed so that braking force is applied by spring pressure. Pressurized air is used to release the braking force exerted by the spring. When a driver manually sets the parking brake, pressurized air is released from the air lines leading to the park brakes. This causes the springs to exert a spring force on braking components to engage the brake. This arrangement is considered a safety feature because an unexpected loss of air pressure in the air lines connected to the parking brakes will cause an application of a strong braking force.

Many heavy duty and bus vehicle fleet owners and operators around the world also use a secondary braking system to reduce vehicle speed. These can vary in application method and operation type. For example, an EMDSR type braking system is well known for this purpose. The single shortcoming of EMDSR type speed reduction mechanisms is that such systems will disengage prior to a vehicle coming to a complete stop. The EMDSR mechanism (“EMDSRM”) disengages because electric retarders produce a torque proportional to speed, therefore as the vehicle speed decreases so does the braking torque. At a low-speed threshold, electric retarders disengage because there is not enough braking torque to effectively slow the vehicle. When this happens, the driver applies the foundation brakes in order to fully stop the vehicle. Embodiments disclosed herein overcome this problem and do not require the presence of vehicle motion to facilitate effectively application of braking forces. As such, the braking system disclosed herein is complimentary to an EMDSRM or other type of secondary braking system. More particular, methods and systems are disclosed herein which provide an automated means to bring a vehicle to a complete stop, even in the event of driver distraction or incapacitation. Additionally, in daily use, the braking system disclosed herein could be used in situations where the driver provides external confirmation that he/she would like the invention to apply (e.g., when the door of a bus opens, etc.).

It is anticipated that one possible application of the braking system disclosed herein can be in conjunction with a forward collision avoidance system that uses an EMDSRM to slow a vehicle's motion in order to avoid an impending collision. In scenarios where the object in the collision pathway is moving slowly or is stationary, the EMDSRM alone will not be able to reduce vehicle speed enough to avoid a collision; the driver must apply the foundation brakes in order to bring the vehicle to a complete stop. Accordingly, embodiments comprising the braking system disclosed are provided to bring a vehicle to a complete stop without any driver intervention; thereby enabling an automated forward collision avoidance system for stationary objects or those moving at a speed below the EMDSRM cut-out threshold speed.

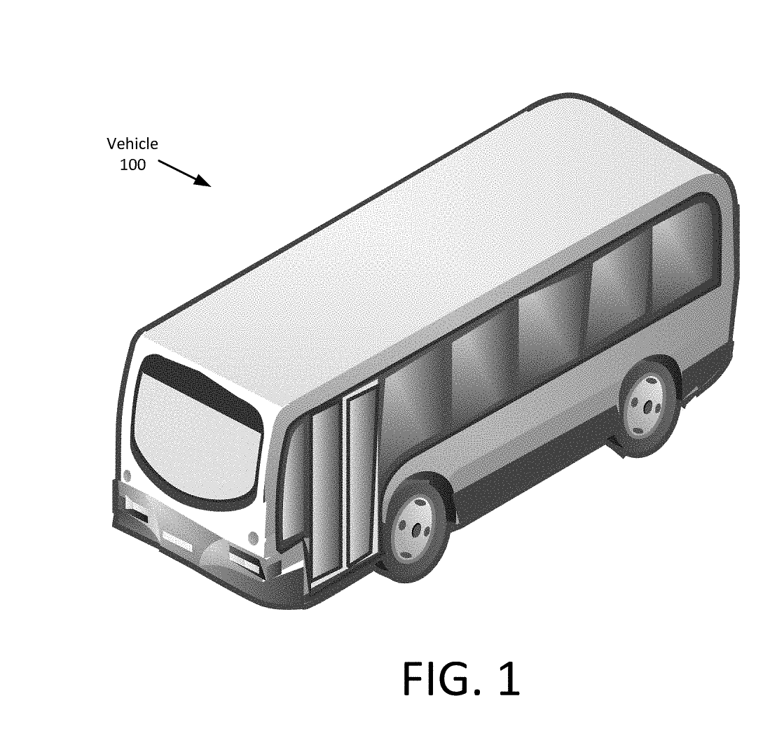

Referring now to FIG. 1, there is provided an illustration of an exemplary vehicle 100. Vehicle 100 includes an air operated service brake system as is commonly included on many commercial vehicles. Compressed air braking systems for commercial vehicles are well known in the art and therefore will not be described here in detail. In an embodiment disclosed herein, vehicle 100 also has a parking brake automatic application system (PBAAS) which complements the function of a secondary brake system (which can be an EMDSRM, for example).

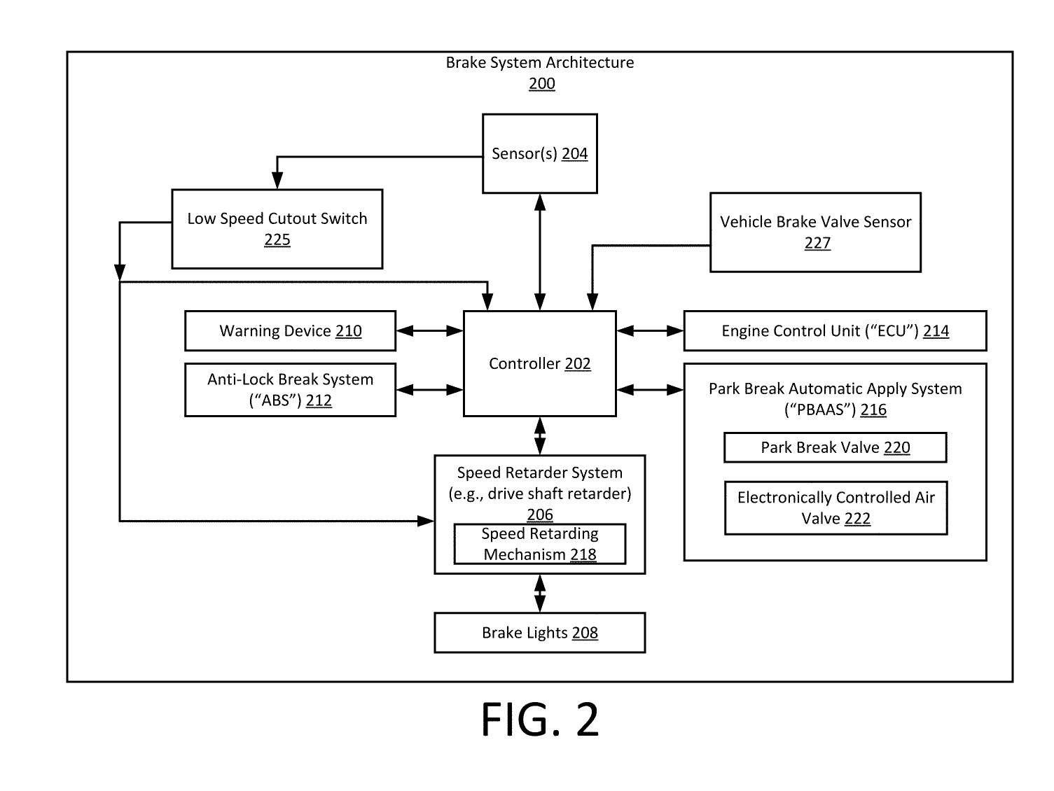

An exemplary braking system architecture (BSA) 200 for vehicle 100 is provided in FIG. 2. In some embodiments a BSA 200 can be configured to actuate a secondary braking system of the vehicle (which is sometimes referred to herein as a “speed retarder”). The purpose of the speed retarder is to decrease the speed of the vehicle under certain conditions. For example, the speed retarder can be part of an overall system for forward collision avoidance. In such scenarios the speed retarder can be used to slow the vehicle, but a PBAAS as disclosed herein is ultimately required to stop the vehicle, particularly if the driver is incapacitated or otherwise inattentive to an impending collision. The electrical components of the BSA 200 are powered by a vehicle power source (e.g., battery or vehicle alternator). For example, the vehicle's power source can supply a voltage (e.g., 12 or 24 volts) to the BSA 200. The present solution for a PBAAS is not limited to the particulars of this example. However, the various components of the BSA will be described below in further detail to facilitate a greater understanding of certain aspects.

As shown in FIG. 2, the BSA 200 comprises components which can include a controller 202, a sensor (e.g., a speed sensor which detects rotation of a transmission output drive shaft using mechanical, electrical or electro-optical means) 204, a low speed cutout switch 225, a speed retarder system 206, a vehicle brake valve sensor 227, and PBAAS 216.

The BSA 200 can further include brake lights 208, warning device (e.g., a light, a buzzer, and/or a speaker) 210, an Anti-lock Brake System (“ABS”) 212, and an Engine Control Unit (“ECU”) 214. Any known or to be known type of speed sensor, brake light, warning device (e.g., light, buzzer or speaker), ABS, and/or ECU can be used herein without limitation. Notably, the BSA 200 may include more or less components than that shown in FIG. 2.

The vehicle brake valve sensor 227 is an electronic sensor (such as a switch) which is configured to signal the controller 202 when the driver of the vehicle 100 has exerted control to activate the vehicle service brake application valve (not shown in FIG. 2). The vehicle service brake application valve is controlled by the driver of vehicle 100 to selectively activate the vehicle's foundation brakes.

The low speed cutout switch 225 can be an electronic circuit that is configured to generate a signal when the sensor 204 detects that the speed of the vehicle has dropped below some predetermined minimum. The exact nature of the electronic circuit is not critical and will necessarily depend on the type of signal that is generated by the sensor 204 to indicate vehicle speed. For example, if the sensor 204 is arranged to generate electrical pulses at a predetermined rate which is proportional to vehicle speed then the low speed cutout switch 225 can comprise a basic digital pulse counter which generates an output signal when the measured pulse rate from the sensor drops below some preset minimum. In some embodiments, the low speed cutout switch 225 can be programmable so that he preset minimum speed can be set. In other scenarios, certain functions associated with the low-speed lockout switch can be integrated with the controller 202. Still, the embodiments are not limited in this regard provided that the functions of a low speed cutout switch are facilitated.

The speed retarder system 206 is comprises a speed retarding mechanism 218 for causing the vehicle's speed to be slowed to a pre-set value (e.g., 5 miles per hour). Speed retarders are well known in the art, and therefore will not be described in detail herein. Any known or to be known speed retarder can be used herein without limitation. For example, the speed retarding mechanism can include, but is not limited to, a drive shaft retarding mechanism, an engine compression retarding mechanism, a transmission input or output retarding mechanism, and/or a driveline retarding mechanism. The speed retarding mechanism can be electric or hydraulic.

Electric retarders uses electromagnetic induction to provide a retardation force. An electric retarder can consist of (a) a rotor attached to the axle, transmission or driveline and (b) a stator securely attached to the vehicle chassis. When retardation is required, the electrical windings of the stator receive power from the vehicle battery, producing a magnetic field through which the rotor moves. This induces eddy currents in the rotor, which produces an opposing magnetic field to the stator. The opposing magnetic fields slows the rotor, and hence the axle, transmission and driveshaft to which it is attached.

Hydraulic retarders use the viscous drag forces between dynamic and static vanes in a fluid-filled chamber to achieve retardation. A hydraulic retarder can consist of vanes attached to a transmission driveshaft between the clutch and roadwheels. The vanes are enclosed in a static chamber with small clearances to the chamber's vaned walls. When retardation is required, fluid is pumped into the chamber, and the viscous drag induced will slow the vehicle.

In some drive shaft retarding scenarios, an Electro-Magnetic Drive Shaft Retarding Mechanism (“EMDSRM”) applies torque to the main drive shaft of the vehicle in order to reduce the drive shaft's speed of rotation, and thus the speed by which the drive wheels of the vehicle are turning. The EMDSRM can include, but is not limited to, an axial retarder available from Telma Retarder, Inc. of Wood Dale, Ill.

In some engine compression retarding scenarios, a speed retarding mechanism inhibits the engine pistons so as to reduce the driveshaft's rotation seed, and thus the drive wheels' rotation speed. The driveshaft's rotation speed can also be reduced by reducing the output rotation speed of the transmission that is situated between the engine and the drive shaft.

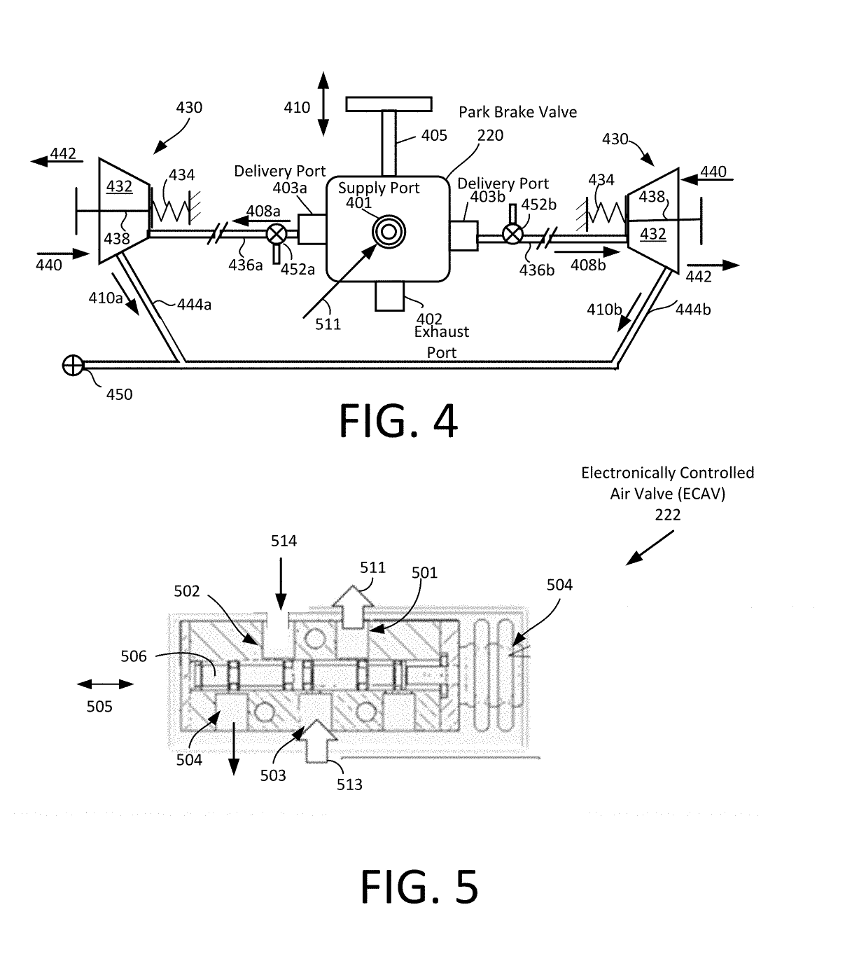

In some scenarios, the speed retarder 206 will not be bring the vehicle 100 to a complete stop. In such scenarios, the controller 202 can performs operations to cause the PBAAS 216 to bring the vehicle to a complete stop. As explained below in greater detail, the PBAAS 216 is also caused to prevent further movement of the vehicle until a park brake valve 220 has been manually released by the driver. Schematic illustrations that are useful for understanding how the park brake valve 220 is controlled are provided in FIGS. 4-5.

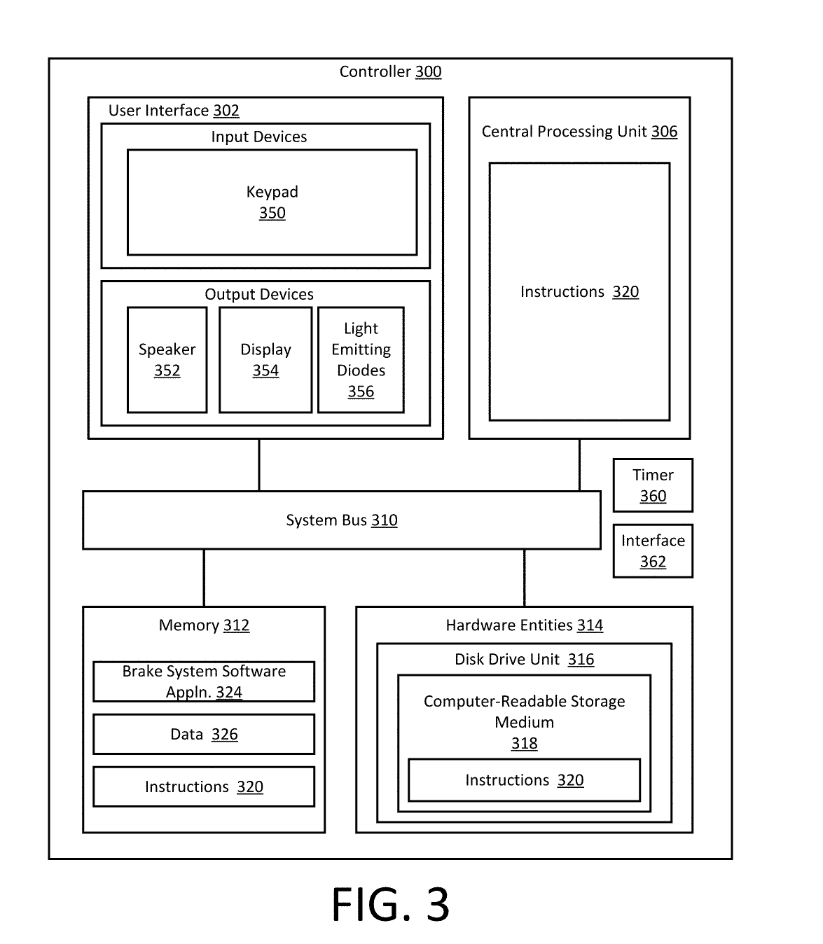

Referring now to FIG. 3, there is provided an illustration of an exemplary architecture for a controller 300. Controller 202 is the same as or substantially similar to controller 300. As such, the following discussion of controller 300 is sufficient for understanding controller 202 of FIG. 2.

Controller 300 may include more or less components than those shown in FIG. 3. For example, the controller can be provided with a coupling mechanism (e.g., a wire harness and/or mounting hardware) for coupling the same to an external object (e.g., the vehicle chassis). However, the components shown are sufficient to disclose an illustrative embodiment implementing the present solution. The hardware architecture of FIG. 3 represents one embodiment of a representative controller configured to facilitate PBAAS operations as described herein. As such, the controller 300 of FIG. 3 can also implements at least a portion of a method for forward collision avoidance which operates in conjunction with the PBAAS.

Some or all the components of the controller 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 3, the controller 300 comprises a user interface 302, a Central Processing Unit (“CPU”) 306, a system bus 310, a memory 312 connected to and accessible by other portions of controller 300 through system bus 310, and hardware entities 314 connected to system bus 310. The user interface can include input devices (e.g., a keypad 350) and output devices (e.g., speaker 352, a display 354, and/or light emitting diodes 356), which facilitate user-software interactions for controlling operations of the controller 300. The output devices can be used to indicate system status (e.g., which operational state the vehicle is in at any given time).

At least some of the hardware entities 314 perform actions involving access to and use of memory 312, which can be a RAM, a disk driver and/or a Compact Disc Read Only Memory (“CD-ROM”). Hardware entities 314 can include a disk drive unit 316 comprising a computer-readable storage medium 318 on which is stored one or more sets of instructions 320 (e.g., software code) configured to implement one or more of the methodologies, procedures, or functions described herein. The instructions 320 can also reside, completely or at least partially, within the memory 312 and/or within the CPU 306 during execution thereof by the controller 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the controller 300 and that cause the controller 300 to perform any one or more of the methodologies of the present disclosure.

In some scenarios, the hardware entities 314 include an electronic circuit (e.g., a processor) programmed for facilitating certain operations described herein. In this regard, it should be understood that the electronic circuit can in some scenarios access and run a PBAAS software application 324 installed on the controller 300. The controller 300 is generally operative to: receive data from one or more sensors (e.g., sensor(s) 204 of FIG. 2); store data 326 in a memory 312; communicate with a speed retarder system 216, and cause a PBAAS 216 to apply a parking brake as described herein. Other functions of the software application 324 will become apparent as the discussion progresses. The controller 300 further comprises an interface 362. The interface 362 facilitates programming of the controller and/or software/parameter updates.

An embodiment PBAAS disclosed herein can sometimes find application in a BSA 200 which comprises a forward collision avoidance system. In scenarios where the BSA 200 includes a forward collision avoidance system, then the controller 300 can include software to perform additional functions. For example, the controller can compute a value representing the risk of collision for the vehicle (e.g., vehicle 100 of FIG. 1); determine when the computed value is greater than a threshold value; perform operations to cause activation of a warning device (e.g., warning device 210 of FIG. 2); perform operations to cause an ECU (e.g., ECU 214 of FIG. 2) to inhibit the vehicle's throttle; start a timer 360; monitor the time to detect when a pre-defined period of time has expired during which the driver did not react to the warning device; and/or instruct a speed retarder (e.g., speed retarder 206 of FIG. 2) to activate brake lights (e.g., brake lights 208 of FIG. 2) and/or slow down the vehicle's speed in order to avoid an impending collision.

An embodiment PBAAS 216 as disclosed herein can work in conjunction with a variety of speed retarder systems 206, however this description will assume use of an EMDSR type of speed retarder system. The speed retarder 206 reduces vehicle speed to a predetermined low speed value. The sensor 204 (e.g. a transmission-mounted speed sensor) provides a speed signal to controller 202 and the EMDSR low speed cut-out switch 225. The low speed cut-out switch 225 can include hardware, firmware, or software to facilitate preconfiguring the particular low speed that will trigger the low speed cut-out of the speed retarder system.

Once the speed of a vehicle 100 is reduced to the preconfigured low speed, the low-speed cutout switch 225 provides an electric signal to disengage the speed retarder system 206 so that it no longer applies a braking force for slowing the vehicle. This signal is also advantageously used as an input to the controller 202, and serves as an indication that that the speed retarder system 206 has disengaged.

The controller 202 can also receive a signal from the vehicle brake valve sensor 227 indicating when the driver has applied the service or foundation brakes. When the driver is in control of the vehicle 100 it can be desirable to avoid automatically activate the parking brake using PBAAS 216. Accordingly, in an embodiment disclosed herein the controller 202 is configured so that it will not send an output signal to PBAAS 216 for activating that system under conditions where a signal from sensor 227 has been received. In other words, the signal from the vehicle brake valve sensor 227 can be used to inhibit automatic braking actions by the PBAAS 216. The reason for this inhibit control is that the signal from the vehicle brake application valve 227 indicates that the driver is in control of the vehicle, and automatic braking is understood to be unnecessary in such a scenario.

In instances where the controller 202 has not received a signal from the vehicle brake valve sensor 227, but has received a signal from the low speed cut-out switch 225, an output signal from the controller is sent to the electric solenoid of an electronically controlled air valve 222 for activating the PBAAS to automatically apply the parking brake.

Referring now to FIG. 4, there is shown a conventional park brake valve 220 which is used in many vehicles, especially commercial vehicles, for applying park brakes 430. A flow of air in the park brake valve is controlled by a push-pull handle 405 which moves in directions indicated by arrow 410 from a first position (e.g., park brake released) to a second position (e.g., park brake asserted). The park brake valve 220 includes an air supply inlet port 401 where a supply of compressed air is provided from an onboard compressed air system in vehicle 100. An exhaust port 402 is provided to exhaust the air from the park brake valve. For example, the air can be exhausted from the park brake valve back to an air tank.

With the handle 405 in the first position the park brake is released. More particularly, with the handle in the first position, two delivery ports 403a, 403b deliver compressed air 408a, 408b to conventional air brake chambers 432 which are respectively associated with the park brakes 430 located at the axle of vehicle 100. Air lines 436a, 436b are provided to facilitate transfer of the pressurized air to the brake chambers 432. As is known, air brake chambers 432 include a flexible diaphragm (not shown). When the air brake chambers 432 are filled with pressurized air, the flexible diaphragm causes a spring 434 to compress. Compression of the spring 434 results in movement of a push rod 438 in direction 440 so as to release the park brakes.

In a conventional park brake system when a driver wishes to activate the park brakes he moves push-pull handle 405, so that the handle 405 is in the second position. In this condition, the park brake valve allows air to be exhausted from the brake chambers 432. More particularly, when the push-pull handle is moved to second position, compressed air in air lines 436a, 436b is permitted to pass from the delivery ports to the exhaust port 402. This results in air from the brake chambers 432, exhausting through the air lines 436a, 436b, and park brake valve to the exhaust port 402. When this occurs, the spring 434 in the park brake is released or decompressed. Decompressing the spring 434 moves the push rod 438 in a second direction 442. This movement of the brake rod in direction 442 causes a braking force to be exerted by the park brake on the wheels at the axle of the vehicle. By returning the handle to its first position, the flow of pressurized air will return to the brake chambers and the park brakes will be once again released.

Notably a conventional park brake valve 220 as described herein is spring-loaded. The driver must assertively move the handle 405 to the first position for releasing the park brakes. But conventional valves of this type will not remain in such first position with the park brake released if the supply of pressurized air to the supply port 401 drops below a predetermined minimum pressure. If such an air pressure drop were to occur, the spring element in the park brake valve 220 will cause the handle 405 to automatically move to the second position. This will cause the park brake valve to exhaust air from the brake chambers, thereby automatically applying the parking brake.

In an embodiment disclosed herein a park brake can be automatically asserted under predetermined conditions by using one or more electronically controlled air valves. In some embodiments, a single multi-port electronically controlled air valve can be used for this purpose. When the park brake is to be asserted, the electronically controlled air valve performs one or more actions as hereinafter described. A first action involves interrupting a flow of pressurized air to a supply port 401 of a park brake valve 220. This can be accomplished by an electronically controlled air valve which closes to prevent further compressed air from flowing to supply port of the park brake valve.

A second action can involve providing an auxiliary or secondary exhaust flow path to facilitate automatically exhausting air from the park brake chambers 432. For example, in one embodiment such an secondary exhaust flow path can be facilitated by an electronically controlled valve 452a, 452b which is configured to selectively allow pressurized air to escape from the park brake air lines 436a, 436b. Such an electronically controlled valve could be disposed anywhere along a length of air lines 436A, 436b. In a second embodiment, the secondary exhaust flow path can be facilitated by using an electronically controlled valve 450 to release air from the park brake chambers 432 through outflow air lines 444a, 444b which selectively allow compressed air 410a, 410b to be released from the air brake chambers.

Alternatively the park brake valve itself can be caused to exhaust the compressed air from the park brake chambers 432. In such a scenario the second action can involve not simply interrupting a flow of compressed air to the supply port 401 (which could still allow pressurized air to remain at the supply port), but instead actively venting or exhausting the compressed air from the supply port 401. As explained above, the intentional loss of air pressure at the supply port 401 will cause the conventional spring loaded park brake valve 220 to automatically transition to its second position (park brake asserted position) in which the exhaust port 402 is opened. This operation of the park brake valve will automatically exhaust any compressed air from the brake chambers 432.

Turning now to FIG. 5 there is shown an illustrative view of an exemplary four-way electronically controlled air valve (ECAV) 222 that is powered by 12 or 24 volt depending on vehicle system. ECAV 222 in this example is a multi-function valve that allows for concurrent control of a plurality of ports. However, it should be appreciated that similar control of a plurality of ports could be achieved with a plurality of electronically controlled air valves. Accordingly, embodiments are not limited to the multi-function valve shown in FIG. 5, which is provided to illustrate one possible example of a valve that could be used for the purposes described herein. Instead, any suitable arrangement of single function or multi-function electronically controlled valves can be used.

In this example, the ports of the ECAV 222 include a normally open port 501 and a normally closed port 502. The ECAV further comprises an air supply inlet port 503. An electrically controlled device such as a solenoid 504 moves a plunger 506 in directions indicated by arrows 505 so as to control the opening and closing of various ports as described. Pressurized air 513 is supplied to the inlet port 503 from the vehicle's pressurized air system. The normally open port 501 is coupled to the air supply port 401 of the park brake valve 222 so that pressurized air flows from port 503, to port 501. Accordingly, a flow of pressurized air 511 is provided to the supply port 401 of a park brake valve

When the ECAV is activated by the solenoid 502, the normally open port 501 is caused to close. Consequently, a flow of pressurized air 511 communicated to the supply port 401 of the brake valve 220 is interrupted. At the same time, the ECAV activation concurrently opens the normally closed port 502. This allows pressurized air 514 from the park brake chambers to flow through the ECAV from port 502 and ultimately be exhausted through port 504. As explained above, the air can be exhausted from the park brake chambers in several ways. For example, in FIG. 4 the valve 450 can be implemented using the normally closed port 502. A similar arrangement with a slightly different configuration could be used to implement electronically controlled valves 452a, 452b.

As a further alternative, the normally closed port 502 could be directly coupled to the normally open port 501 (which supplies pressurized air to the supply port 401). In ECAV 222 the normally closed port 502 is opened concurrently as port 501 is closed. Consequently, any pressure remaining at the supply port 401 will be immediately exhausted through valve 502 as the flow of pressurized air to the supply port is being cut off by valve 501. This loss of pressure at the supply port would cause the spring loaded park brake valve to automatically transition to its second position, thereby exhausting pressurized air from the brake chambers to the exhaust port 402 (through air lines 436a, 436b). This will activate the park brake as described above and safely bring the vehicle to a full stop.

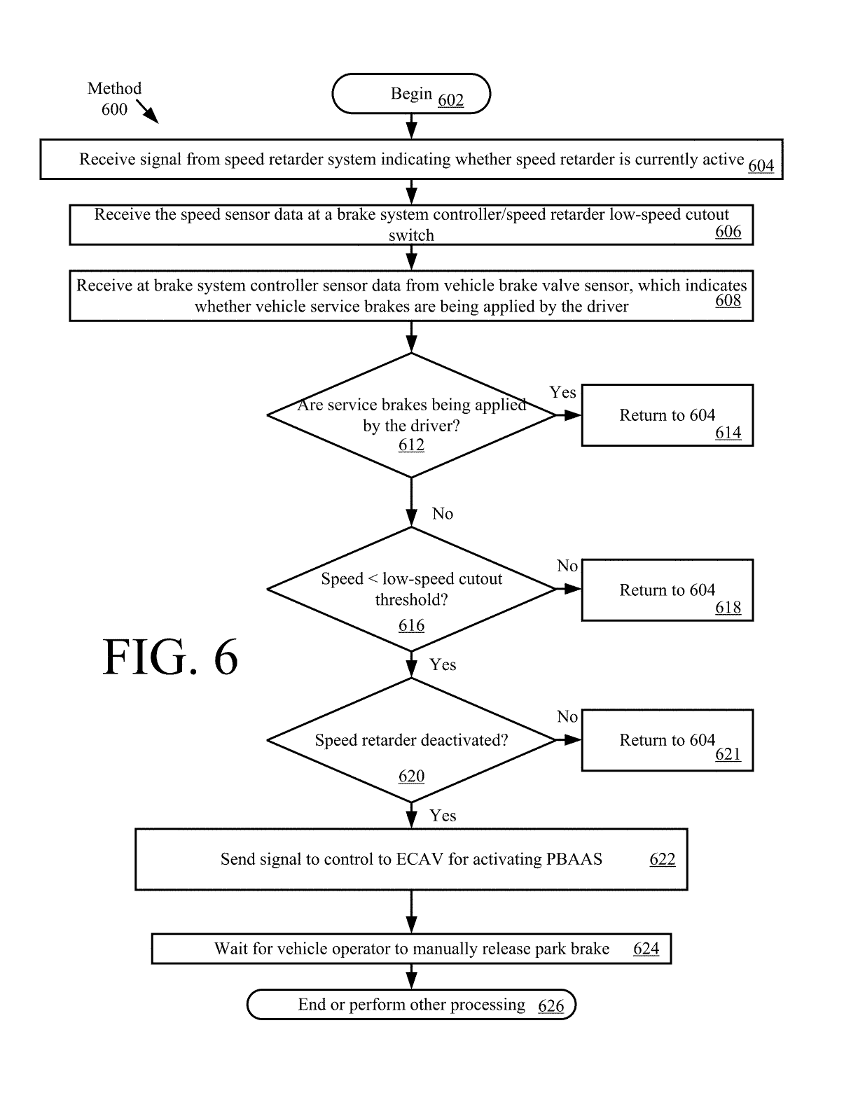

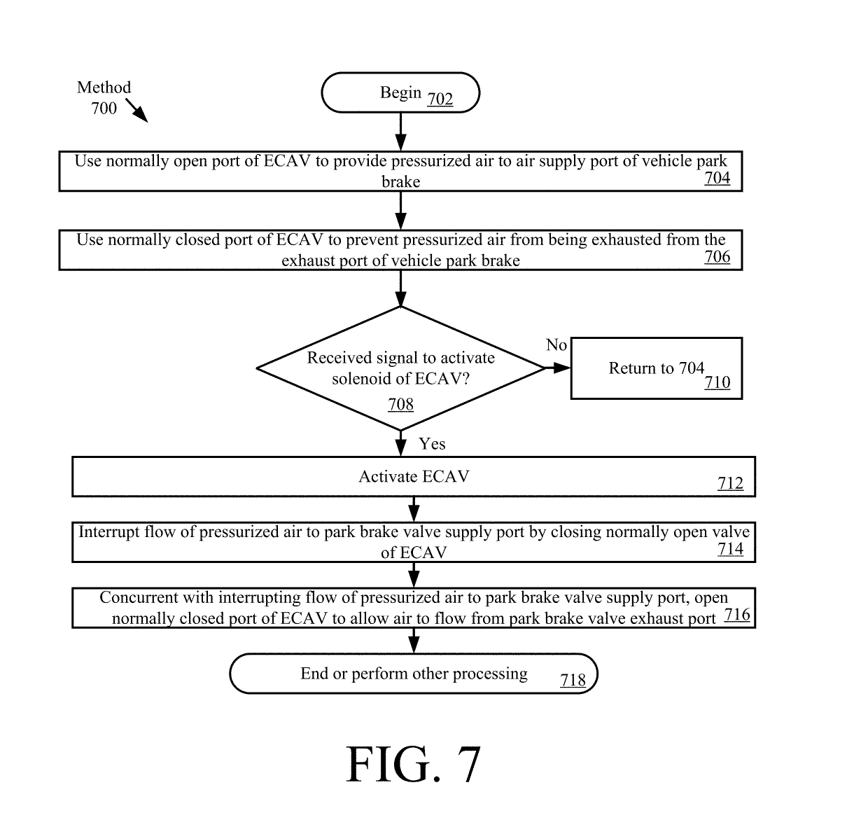

In order for the park brake to be applied, the current embodiment takes into account (a) whether the driver has applied the vehicle service brakes (i.e., the foundation brakes), (b) if the vehicle speed is below a predetermined low-speed threshold, and (c) whether the EMDSR has been deactivated. These features are disclosed in greater detail in relation to flowcharts shown in FIGS. 6 and 7.

FIG. 6 is a flowchart that is useful for understanding a method 600 for determining when the PBAAS system described herein should be activated. The process begins at 602 and continues to 604 where a brake system controller (e.g. controller 202) receives a signal from the speed retarder system indicating a speed retarder mechanism (e.g. an EMDSRM) state. This signal can indicate whether the speed retarder is currently active or inactive. The process then continues on to 606 where the speed sensor data is received at a speed retarder low speed cutout switch (e.g. low speed cutout switch 225). This information is advantageously also provided to the brake system controller. The process continues at 608 where a signal or data from a brake valve sensor is received at the brake system controller. The vehicle brake valve sensor is a sensor adapted to generate a signal when the service brakes are applied by a vehicle driver (e.g., a switch).

The process continues at 612 where a determination is made at the brake system controller as to whether the service brakes are being applied by the driver. This can be determined based on the signal received from the brake valve sensor in step 608. If so (612: Yes), then the PBAAS will not be activated and the method returns to 604. If the brakes are not being applied (612: No) then the process continues on to 616 where a determination is made as to whether the vehicle speed is less than a speed retarder low-speed cutout switch. This can be accomplished by comparing the current vehicle speed to a predetermined threshold speed at which the speed retarder system will automatically cut-out. If the speed is too high (616: No), then the method returns to 604. However, if the speed is below the preset threshold (616: Yes) then the process continues on to 620 where the system determines whether the speed retarder has in fact been deactivated. Such verification can be based on the signal received from the speed retarder system at 604.

If the speed retarder is inactive (620: Yes), then the process continues on to 622 where a signal is sent to control the ECAV so as to activate the PBAAS. Once the PBAAS has been activated in this way, the controller can wait for the vehicle operator to manually release the park brake at 624. At 626, the method can end or the controller can continue with other processing.

Turning now to FIG. 7, the PBAAS method 700 can begin at 702 and continue to 704 where a normally open port of the ECAV is maintained in its open position to provide pressurized air to an air supply port of vehicle park brake. The process continues at 706 where a normally closed port of the ECAV is maintained in its closed position to prevent pressurized air from being exhausted from the exhaust port of vehicle park brake. The process continues on to 708 where a determination is made as to whether an activation signal has been received at the solenoid of an ECAV. If the signal is not received, then the process returns at 710 to 704. However, if the solenoid activation signal is received (708: Yes) then the process continues to 712 where the ECAV is activated to control certain air valves as hereinafter described. In particular, at 714 the ECAV will interrupt the flow of pressurized air to a park brake valve supply port by closing the normally open valve of the ECAV. Concurrent with interrupting such air flow, the ECAV will open the normally close port of the ECAV to allow air to flow from the park brake valve exhaust port. These operations will result in the park brake valve activating the park brake at the vehicle axle.

It will be apparent to those skilled in the field of commercial vehicle operations that there can be various system configurations and user adaptations to the operation of the present solution. It will also be apparent to those in the field of maintenance and repair that there can be various modifications and variations made to the installation and programming methods without departing from the scope or spirit of the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for automatic activation of a park brake, comprising:
providing a source of pressurized air in a vehicle;
releasing a park brake by supplying the pressurized air through a delivery port of a park brake valve to a park brake air chamber;
responsive to a control signal, automatically
interrupting a flow of the pressurized air to a supply port of the park brake valve and,
concurrent with the interrupting, providing an exhaust flow path to allow pressurized air to be exhausted from a park brake air chamber whereby the park brake is applied for slowing the vehicle.

2. The method according to claim 1, further comprising providing the exhaust flow path using at least one electronically controlled air valve (ECAV).

3. The method according to claim 2, wherein the exhaust flow path is provided at a location disposed between the park brake air chamber and the delivery port.

4. The method according to claim 2, wherein the exhaust flow path is provided in a port coupled to the park brake air chamber.

5. The method according to claim 2, wherein the exhaust flow path is provided through an exhaust port of the park brake valve.

6. The method according to claim 5, wherein the at least one ECAV exhausts pressurized air from the supply port of the park brake valve concurrent with interrupting the flow of pressurized air to the supply port.

7. The method according to claim 5, wherein the park brake valve is disposed in a first valve position when said park brake is released, and responsive to the absence of pressurized air at the supply port automatically transitions to a second valve position.

8. The method according to claim 7, wherein in the second valve position the park brake valve allows compressed air from the park brake air chamber to return through the delivery port and be exhausted through the exhaust port of the park brake valve.

9. The method according to claim 1, wherein said control signal is generated concurrently with, or immediately following, the operation of a secondary vehicle speed retarder system.

10. The method according to claim 1, wherein said control signal is automatically selectively inhibited if a vehicle service brake is being applied by a driver of the vehicle.

11. A Park Brake Automatic Application System (PBAAS), comprising:
a source of pressurized air;
a manually controlled park brake valve which is adapted to control a supply of the pressurized air to a park brake air chamber, the park brake valve including a supply port, at least one delivery port, and an exhaust port;
at least one electronically controlled air valve (ECAV);
an electronic controller which is responsive to at least one input signal to generate a control signal to control the at least one ECAV when the PBAAS is activated;
wherein the at least one ECAV is responsive to the control signal to
interrupt a flow of the pressurized air to the supply port of the park brake valve by closing a normally open port, and
concurrent with said closing, also opening a normally closed port to provide a flow path to allow pressurized air to be exhausted from the park brake air chamber.

12. The PBAAS according to claim 11, wherein the ECAV includes a first port for receiving a flow of the pressurized air, and the normally open port is coupled to the supply port of the park brake valve to communicate the pressurized air from the first port to the supply port.

13. The PBAAS according to claim 12, wherein the exhaust flow path is provided at a location disposed between the park brake air chamber and the at least one delivery port.

14. The PBAAS according to claim 12, wherein the exhaust flow path is provided in a port that is coupled to the park brake air chamber.

15. The PBAAS according to claim 12, wherein the exhaust flow path is provided through the exhaust port of the park brake valve.

16. The PBAAS according to claim 15, wherein the at least one ECAV is configured to exhaust pressurized air from the supply port of the park brake valve concurrent with interrupting the flow of pressurized air to the supply port.

17. The PBAAS according to claim 15, wherein the park brake valve has:
a first valve position in which the pressurized air to the supply port is applied to the park brake chamber through the delivery port so that said park brake is released,
a second valve position in which pressurized air is released from the park brake chamber so that the park brake is applied; and
the park brake is responsive to the absence of pressurized air at the supply port to automatically transition to the second valve position.

18. The PBAAS according to claim 17, wherein in the second valve position the park brake valve allows compressed air from the park brake air chamber to return through the delivery port and be exhausted through the exhaust port of the park brake valve.

19. The PBAAS according to claim 1, wherein the electronic controller is responsive to at least one input signal to selectively prevent the PBAAS from activating the park brake.

20. The PBAAS according to claim 19, wherein the at least one input signal indicates at least one of a vehicle speed, a speed retarder system activation state, and a manual activation of a vehicle service brake.

21. A Park Brake Automatic Application System (PBAAS), comprising:
a source of pressurized air;
a manually controlled park brake valve which is adapted to control a supply of the pressurized air to a park brake air chamber, the park brake valve including a supply port, at least one delivery port, and an exhaust port;
at least one electronically controlled air valve (ECAV);
an electronic controller which is responsive to at least one input signal to generate a control signal to control the at least one ECAV when the PBAAS is activated;
wherein the at least one ECAV is responsive to the control signal to
interrupt a flow of the pressurized air to the supply port of the park brake valve, and
concurrent with said interrupt, providing a flow path to allow pressurized air to be exhausted from the park brake air chamber.
